(19) United States
(12) Patent Application Publication
(10) Pub. No.: US 2019/0112872 A1
(43) Pub. Date: Apr. 18, 2019

(54) ROPE ASSEMBLY FOR WINDOW BLINDS

(71) Applicants: SHENG YING HSU, Changhua County (TW); CHUN JAN HSU, Changhua County (TW)

(72) Inventors: SHENG YING HSU, Changhua County (TW); CHUN JAN HSU, Changhua County (TW)

(21) Appl. No.: 15/786,812

(22) Filed: Oct. 18, 2017

(51) Int. Cl. E06B 9/326; E06B 9/323

(52) U.S. Cl. CPC E06B 9/326; E06B 9/322; E06B 9/323

(57) ABSTRACT

A rope assembly of window blinds includes multiple ropes which are respectively located at front side of the slats and at rear side of the slats of the window blinds. The ropes are connected to a control unit received in the top box of the window blinds. Each rope is received in a sleeve, and at least one support wire is connected between the sleeves located on the front and rear sides of the slats which are supported on the at least one support wire. The at least one support wire controlled by the control unit to lift or lower the slats. The ropes are protected by the sleeves and the sleeves provide aesthetic features.

### BACKGROUND OF THE INVENTION

### 1. Fields of the Invention

The present invention relates to a rope assembly, and more particularly, to a rope assembly of window blinds, wherein the ropes are hidden in sleeves.

### 2. Descriptions of Related Art

The conventional window blinds 50 as disclosed in FIGS. 5 and 6 comprises the slat assembly 51, multiple transmission ropes 52 and multiple control ropes 53. The transmission ropes 52 are connected to the control ropes 53. The slat assembly 51 includes multiple slats 54, and the transmission ropes 52 extend through the slats 54 and are connected between the top box and the bottom rail of the window blinds 50. The control ropes 53 are connected to the control unit in the top box to lift or lower the slat assembly 51 by operating the transmission ropes 52 when pulling the control ropes 53. However, the transmission ropes 52 are made of fibers which are worn out due to friction after being used for a period of time. Once the transmission ropes 52 are worn out, they cannot properly operate the slates 54 as shown in FIG. 6, so that the slat assembly 51 tilts or even hit persons walking by. Furthermore, the control ropes 53 are exposed outside of the slat assembly 51, and can be pulled and wrapped around children necks when children are playing the exposed. The loosen control ropes 53 may be dangerous to children.

The present invention intends to provide a rope assembly of window blinds, wherein the ropes are hidden in sleeves which protect the ropes inside and also provide aesthetic features.

### SUMMARY OF THE INVENTION

The present invention relates to a rope assembly of window blinds, and the window blinds include a top box and a bottom rail. Multiple slats are located between the top box and the bottom rail. The slats are located between multiple ropes which are respectively located at the front side of the slats and at the rear side of the slats. The ropes are connected to a control unit received in the top box. Each rope is received in a sleeve, and at least one support wire is connected between the sleeves located on the front and rear sides of the slats which are supported on the at least one support wire. The at least one support wire is controlled by the control unit to lift or lower the slats.

The advantages of the present invention are that the ropes are hidden in the sleeves which look decoratively beautiful in a room.

The sleeves are made by knitting laces and the support wires are sewed to the sleeves. The knitting laces look elegant and luxury.

The top box includes holes in the bottom thereof, and the ropes and the sleeves extend through the holes. The sleeves are secured to the holes by securing members.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the rope assembly of window blinds of the present invention;

FIG. 2 shows the sleeves, the ropes and the support wires of the rope assembly of window blinds of the present invention;

FIG. 3 shows that the window blinds are lifted;

FIG. 4 shows that the sleeves and the ropes are cooperated with securing members, and are connected to the control unit;

FIG. 5 is a side view to the conventional window blinds, and

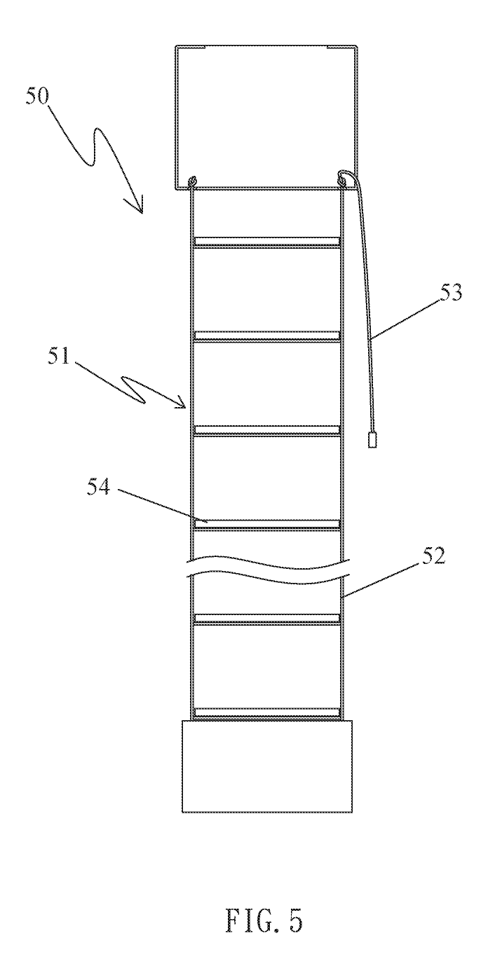

FIG. 6 shows that the conventional window blinds tilt because at least one of the transmission ropes is worn out.

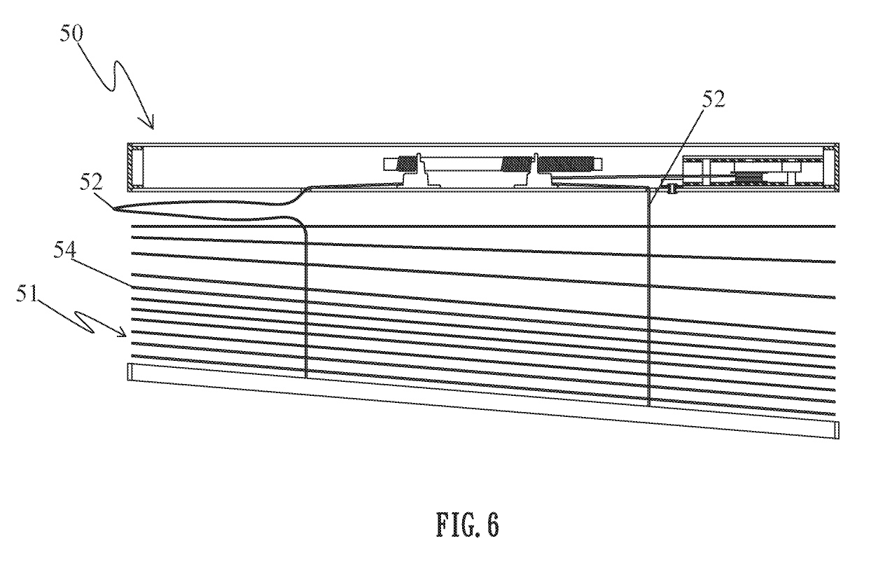

### DETAILED DESCRIPTION OF THE PREFERRED EMBODIMENT

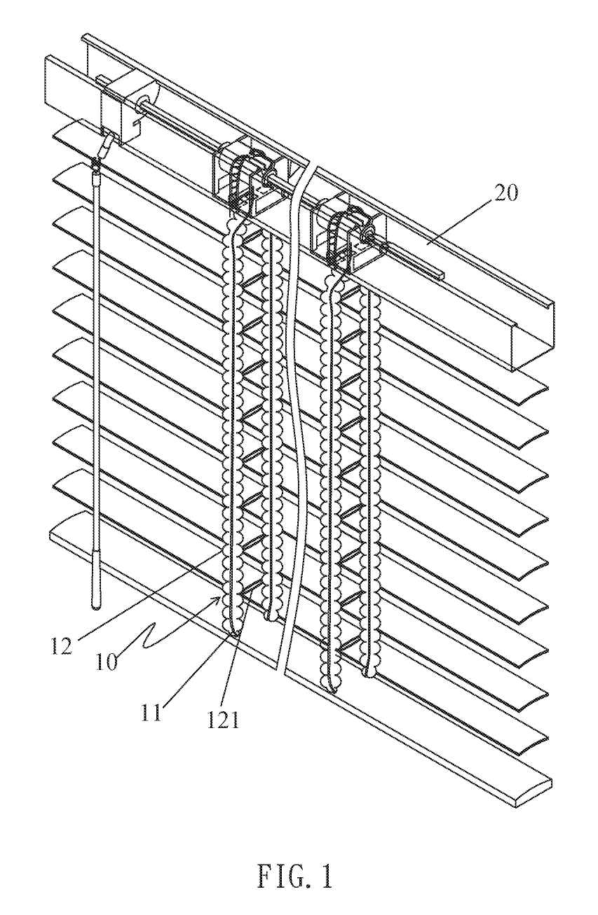

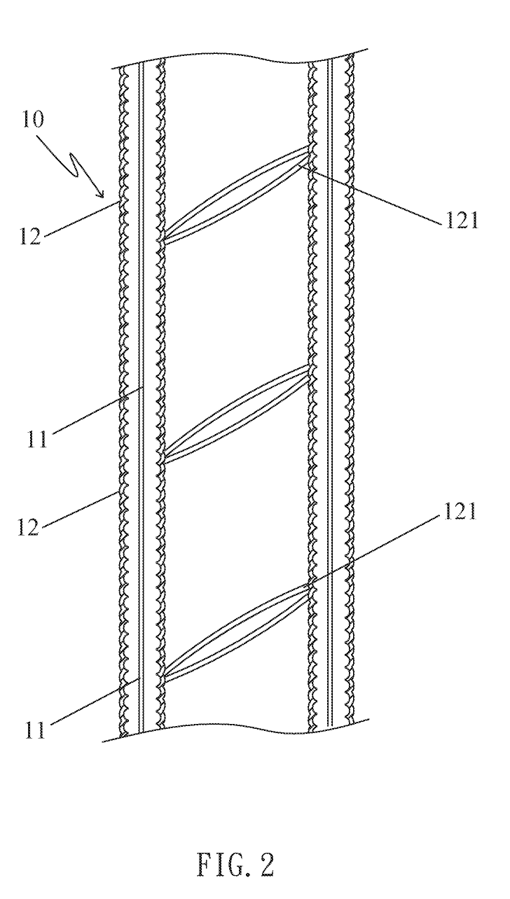

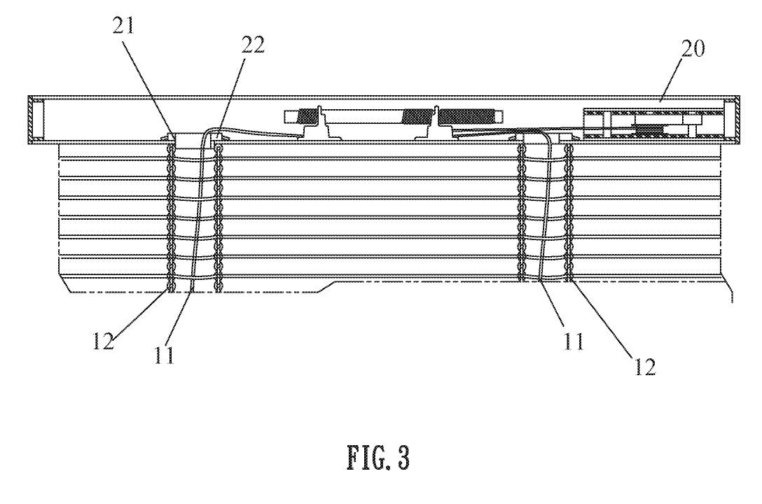

Referring to FIGS. 1 to 4, the window blinds include a top box and a bottom rail. Multiple slats are located between the top box and the bottom rail. The slats are located between multiple ropes 11 which are respectively located at the front side of the slats and at the rear side of the slats. The ropes 11 are connected to a control unit 20 received in the top box.

Each rope 11 is received in a sleeve 12, and the sleeves 12 are made by knitting laces in this embodiment. At least one support wire 121 is connected between the sleeves 12 located on the front and rear sides of the slats. The slats are supported on the at least one support wire 121. The at least one support wire 121 is controlled by the control unit 20 to lift or lower the slats.

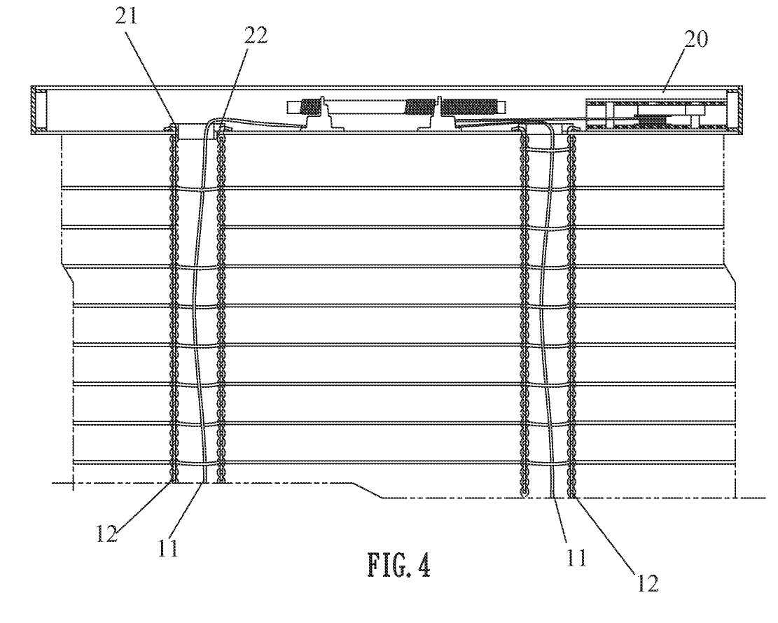

The top box includes holes 21 defined through the bottom thereof, and each hole 21 has a securing member 22 engaged therewith. The securing members 22 each are a T-shaped member with three open ends and a top opening. The three open ends and the top opening communicate with each other. The rope 11 extends through the securing member 22 corresponding thereto, and extends through the top opening so as to be connected with the control unit 20. The sleeve 12 is mounted and secured on outside of the securing member 22 corresponding thereto as shown in FIG. 4.

The ropes 11 are hidden in the sleeves 12 which look decoratively beautiful in a room. The at least one support wire 121 is sewed to the sleeves 12, and the slats are supported on the at least one support wire 121. The distance between any of the two adjacent at least one support wires 121 is short, so that even when the rope 11 and the sleeve 12 are pulled by children, only the distance between any of the two adjacent at least one support wires 121 is pulled, the short length of the rope 11 and the sleeve 12 does not harm to the children.

While we have shown and described the embodiment in accordance with the present invention, it should be clear to those skilled in the art that further embodiments may be made without departing from the scope of the present invention.

What is claimed is:

1. A rope assembly of window blinds which include a top box and a bottom rail, multiple slats located between the top box and the bottom rail, the slats located between multiple ropes, the multiple ropes respectively located at front side of the slats and at rear side of the slats, the ropes connected to a control unit received in the top box, wherein:
each rope received in a sleeve, at least one support wire connected between the sleeves located on the front and rear sides of the slats which are supported on the at least one support wire, the at least one support wire controlled by the control unit to lift or lower the slats.

2. The rope assembly of window blinds as claimed in claim 1, wherein the sleeves are made by knitting laces.

3. The rope assembly of window blinds as claimed in claim 1, wherein the top box includes holes defined through a bottom thereof, the ropes and the sleeves extend through the holes, the sleeves are secured to the holes by securing members.

4. The rope assembly of window blinds as claimed in claim 3, wherein the securing members each are a T-shaped member with three open ends and a top opening, the three open ends and the top opening communicate with each other, the rope extends through the securing member corresponding thereto, the sleeve is secured on outside of the securing member corresponding thereto.
